(19) United States
(12) Patent Application Publication
(10) Pub. No.: US 2021/0220207 A1
(43) Pub. Date: Jul. 22, 2021

(54) WEARABLE ROBOT

(71) Applicant: LG ELECTRONICS INC., Seoul (KR)

(72) Inventors: Jinju KIM, Seoul (KR); Seongmin KIM, Seoul (KR); Kyutae PARK, Seoul (KR); Sojin PARK, Seoul (KR); Seunghyun SONG, Seoul (KR); Wookjun CHUNG, Seoul (KR)

(21) Appl. No.: 16/652,717

(22) PCT Filed: Jan. 2, 2019
(86) PCT No.: PCT/KR2019/000060

§ 371 Date: Apr. 1, 2020

(51) Int. Cl. A61H 3/00; A61H 1/02; B25J 9/00

(52) U.S. Cl. CPC A61H 3/00; A61H 1/0244; B25J 9/0006; A61H 2003/007; A61H 2201/1671; A61H 2201/1659; A61H 2201/163; A61H 2201/1642; A61H 2201/165

(57) ABSTRACT

A wearable robot in accordance with an embodiment of the present invention, comprises: a rear supporting portion disposed behind a body of a user; a hip joint driving unit including a center portion fastened to the rear supporting portion and a pair of extensions portions extending from the center portion to a hip joint of the user; a contact pad fastened in front of the rear supporting portion and brought into close contact with a back of the body of the user; and a binder rotatably connected to the rear supporting portion and configured to press the contact pad.

### TECHNICAL FIELD

The present disclosure relates to a wearable robot, and more particularly, to a wearable robot that assists a wearer's strength.

### BACKGROUND ART

In recent years, robot technology has been applied to a wide range of fields. Among them, wearable robots are being used for those who have difficulty in walking due to their weakness caused by disability or aging.

A wearable robot is a type of muscle aiding device that assists a wearer's strength. More specifically, the wearable robot serves to assist the user's strength when walking or lifting a heavy load while wearing the wearable robot. To this end, the muscle aiding device may assist the action of the user by providing the user with an assist force generated from a driving device such as a motor.

Such a wearable robot may be worn on the user's waist and legs. The muscle aiding device has a number of components to be worn on each part of the body of the user. A driving part such as a motor among the plurality of components plays an important role in transmitting an assist force to a joint part of the body of the user.

As the prior art related thereto, there are Korean Registration Patent Number 10-1219795 and US Patent Application Publication No. 2015-0134080.

However, the conventional wearable robot has a problem that the wearing of the wearable robot is inconvenient and the wearer feels uncomfortable upon wearing.

### DISCLOSURE OF THE INVENTION

### Technical Problem

One technical problem to be solved by the present invention is intended to provide a wearable robot which has been stably worn and maintained on a user.

The other technical problem to be solved by the present invention is intended to provide a wearable robot through which the user feels comfortable.

### Technical Solution

The wearable robot according to an embodiment of the present invention comprises: a rear supporting portion disposed behind a body of a user; a hip joint driving unit including a center portion fastened to the rear supporting portion and a pair of extensions portions extending from the center portion to a hip joint of the user; a contact pad fastened in front of the rear supporting portion and brought into close contact with a back of the body of the user; and a binder rotatably connected to the rear supporting portion and configured to press the contact pad.

The contact pad comprises: a support plate fastened to the rear supporting portion and including a hard material; and a cushion provided on a front surface of the support plate, having an elastic material and closely contacting the body of the user.

A protrusion portion protruding toward the rear supporting portion may be formed on a back surface of the support plate, and an insertion groove into which the protrusion portion is inserted may be formed on a front surface of the rear supporting portion.

The binder comprises: a first binder configured to press the contact pad in one side thereof; and a second binder spaced apart from the first binder in a horizontal direction and configured to press the contact pad in the other side thereof, wherein the contact pad may be disposed between the first binder and the second binder.

The wearable robot further comprises a belt configured to connect the first binder and the second binder and be adjustable in length, wherein the first binder and the second binder are spaced apart from the contact pad if the belt is a first length, and the first binder and the second binder may contact and press the contact pad, if the belt is a second length shorter than the first length.

The binder may include a pair of upper binders spaced apart from each other in a horizontal direction and pressing both top sides of the contact pad; and a pair of lower binders spaced apart from each other in a horizontal direction and pressing both bottom sides of the contact pad. Part of the top side of the contact pad may be disposed between the pair of upper binders, and part of the bottom side of the contact pad may be disposed between the pair of lower binders.

A curvature of an inner side of the lower binder may be greater than a curvature of an inner side of the upper binder.

A waist contact pad may be larger than the binder.

An inner surface of the binder may include a pressing portion in contact with the contact pad, and the pressing portion may include an elastic material.

The wearable robot may include a rear cover for covering part of a top side among an opened bear surface of the rear supporting portion, and the center portion may cover part of a bottom side among the opened bear surface of the rear supporting portion.

The wearable robot may include a light emitting unit disposed between the rear cover and the center portion.

The rear supporting portion may comprise: an upper supporting portion disposed at a back of the user; and a lower supporting portion disposed in a bottom side of the upper supporting portion, disposed at a waist of the user and fastened in the center portion.

The contact pad may be fastened in the front of the lower supporting portion.

The robot may further comprise: a leg mounting portion configured to cover a thigh of the user; a rotor included in a bottom end of the extension portion and rotated on a long rotating shaft in a left and right direction; and a leg frame revolved by the rotor and connected to the leg mounting portion.

The leg mounting portion may comprise a leg binder having a circular arc shape and including a hardened material and a leg belt connecting both ends of the leg binder and including a soft material.

The leg frame may be connected to a front end of the leg mounting portion.

An upper end of the leg frame may be connected to the rotor, both sides of the upper end of the leg frame may face right and left, respectively, a lower end of the leg frame may be connected to the leg mounting portion, and both sides of the lower end of the leg frame may face back and forth, respectively.

The rotor and the leg frame may be connected to each other, and a connector having a long hinge axis back and forth.

### BRIEF DESCRIPTION OF THE DRAWINGS

FIG. 1 is a view illustrating a state in which a wearable robot according to an embodiment is worn by a user.

FIG. 2 is a view illustrating a state in which the wearable robot according to an embodiment is worn by the user, when viewed in a different direction.

FIG. 3 is a perspective view of the wearable robot according to the embodiment.

FIG. 4 is a front view of the wearable robot according to the embodiment.

FIG. 5 is a rear view of the wearable robot according to the embodiment.

FIG. 6 is a right side view of the wearable robot according to the embodiment.

FIG. 7 is a left side view of the wearable robot according to the embodiment.

FIG. 8 is a view illustrating the inside of a rear supporting portion according to an embodiment.

FIG. 9 is a view illustrating a state in which a contact pad is mounted on the rear supporting portion, according to an embodiment.

FIG. 10 is a rear view of the contact pad according to the embodiment.

FIG. 11 is a plan view of the wearable robot according to the embodiment.

FIG. 12 is a view illustrating an upper binder and a contact pad according to an embodiment.

FIG. 13 is a view illustrating a lower binder and a contact pad according to an embodiment.

FIG. 14 is a rear view illustrating an upper rotational shaft and a lower rotational shaft according to an embodiment.

FIG. 15 is a side view illustrating the upper rotational shaft and the lower rotational shaft according to an embodiment.

### DETAILED DESCRIPTION OF THE PREFERRED EMBODIMENTS

Hereinafter, specific embodiments will be described in detail with reference to the accompanying drawings.

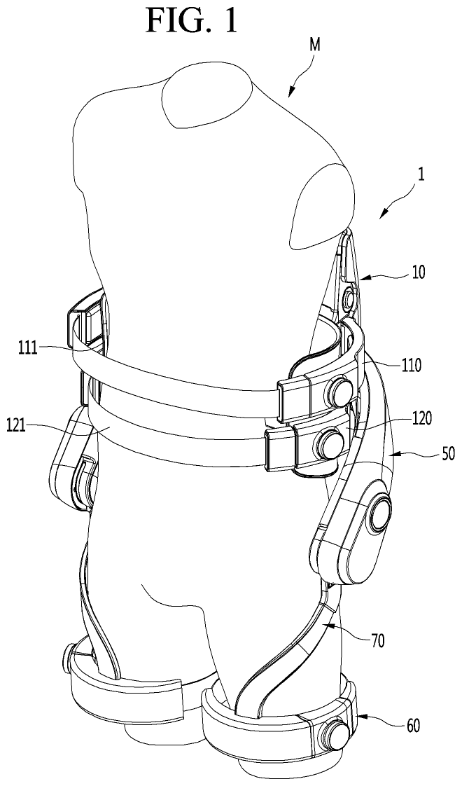

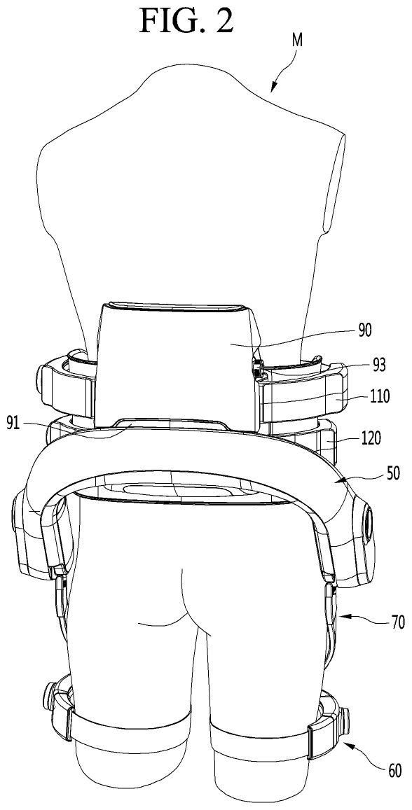

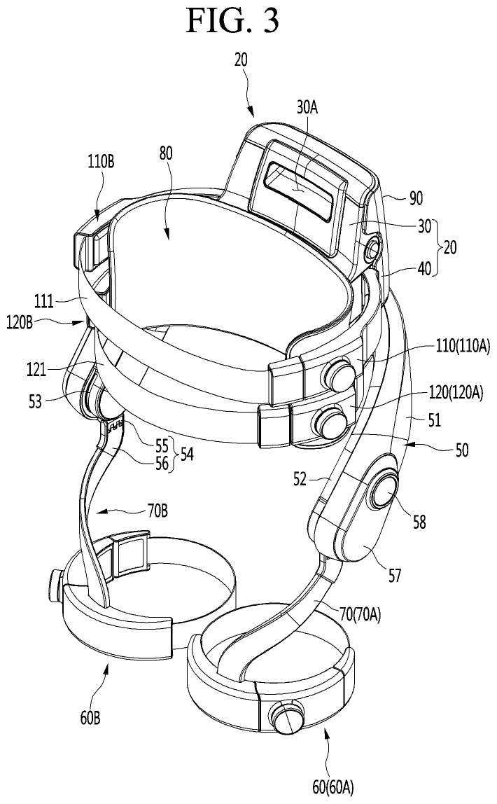

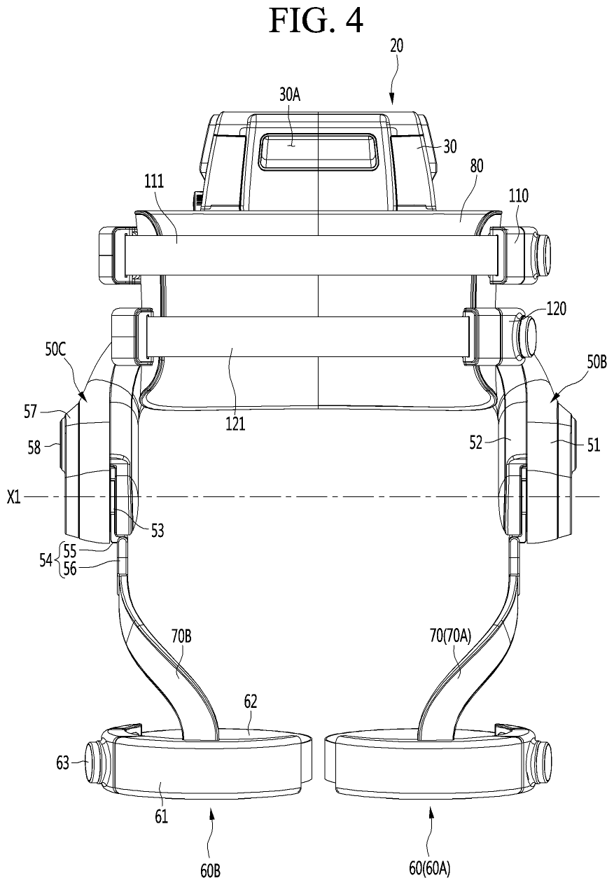

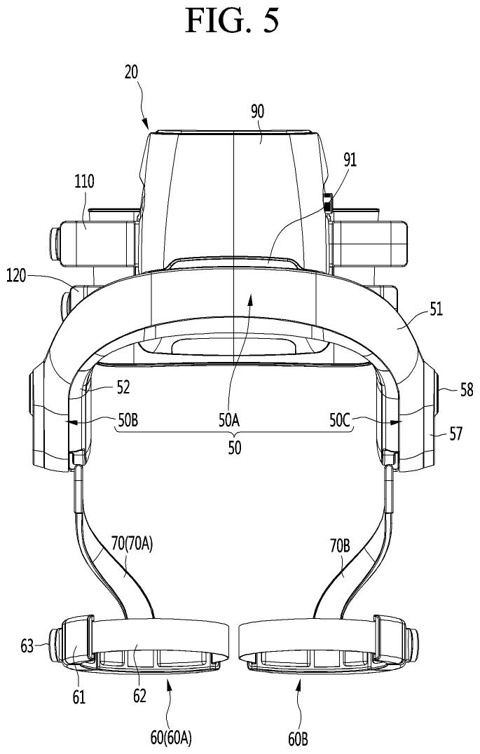

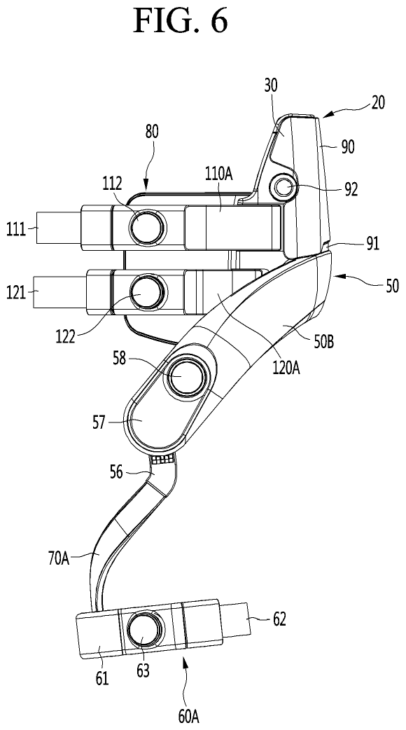

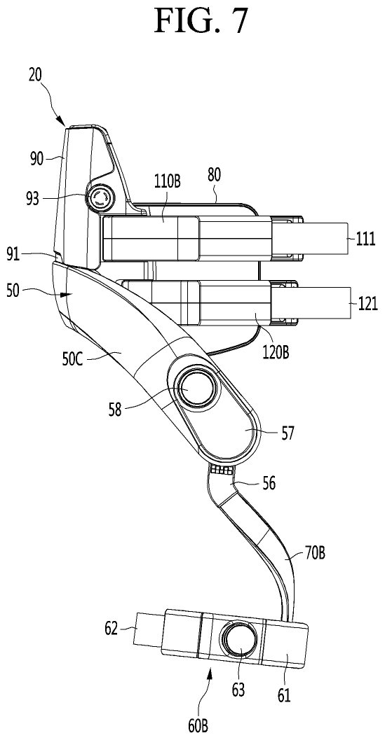

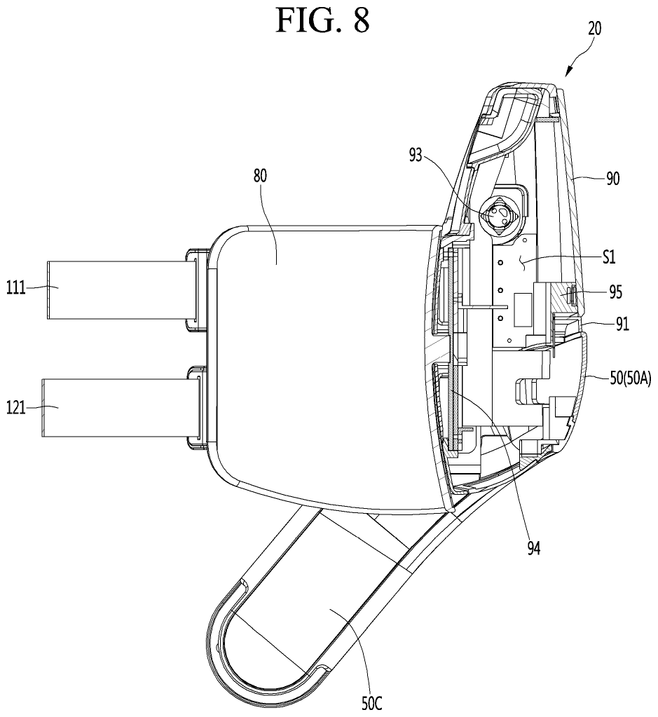

FIG. 1 is a view illustrating a state in which a wearable robot according to an embodiment is worn by a user, FIG. 2 is a view illustrating a state in which the wearable robot according to an embodiment is worn by the user, when viewed in a different direction, FIG. 3 is a perspective view of the wearable robot according to the embodiment, FIG. 4 is a front view of the wearable robot according to the embodiment, FIG. 5 is a rear view of the wearable robot according to the embodiment, FIG. 6 is a right side view of the wearable robot according to the embodiment, FIG. 7 is a left side view of the wearable robot according to the embodiment, and FIG. 8 is a view illustrating the inside of a rear supporting portion according to an embodiment.

A wearable robot 1 according to an embodiment may be worn on a body M of a user.

The wearable robot 1 may include a main body 10.

The main body 10 may form the appearance of the wearable robot 1.

The main body 10 may include a rear supporting portion 20 and a hip joint driving unit 50.

The rear supporting portion 20 may be disposed behind the body M of the user. The rear supporting portion 20 may be formed in a substantially box shape, but is not limited thereto.

A light emitting portion 91 may be provided on the rear surface of the rear supporting portion 20. The light emitting portion 91 may emit or flicker light.

The light emitting portion 91 may be disposed between a rear cover 90 and the hip joint driving unit 50.

The use of the light emitting portion 91 is not limited. For example, when the user wearing the wearable robot 1 is in a dark place, another person may easily recognize the position of the user wearing the wearable robot 1 by the light emitted from the light emitting portion 91.

In addition, switches 92 and 93 may be provided on at least one of both side surfaces of the rear supporting portion 20.

The switches 92 and 93 may be provided at the upper portion on the side surface of the rear supporting portion 20. Therefore, the user may easily press or operate the switches 92 and 93.

The types of the switches 92 and 93 are not limited. For example, the power switch 92 may be provided on one side of the rear supporting portion 20, and the emergency stop switch 93 may be provided on the other side of the rear supporting portion 20.

A space S1 (see FIG. 8) may be formed in the rear supporting portion 20. A controller 94 for controlling the overall operation of the wearable robot 1 may be accommodated in the space S1. The controller 94 may include a PCB.

In addition, a light emitting PCB 95 for controlling the light emitting portion may be accommodated in the space S1 inside the rear supporting portion 20. The light emitting PCB 95 may be electrically connected to the controller 94.

The rear surface of the rear supporting portion 20 may be opened. In this case, part of the opened rear surface of the rear cover 90 may be covered by the rear cover 90, and the other part may be covered by a center portion 50A of the hip joint driving unit 50.

The rear cover 90 may be disposed above the center portion 50A of the hip joint driving unit 50. The light emitting portion 91 may be provided between the rear cover 90 and the center portion 50A.

The rear supporting portion 20 may include an upper supporting portion 30 and a lower supporting portion 40 disposed below the upper supporting portion 30.

For example, the upper supporting portion 30 may be disposed behind the back of the user, and the lower supporting portion 40 may be disposed behind the waist of the user.

The upper supporting portion 30 and the lower supporting portion 40 may be integrally formed.

A handle groove 30A may be formed in the upper supporting portion 30.

The handle groove 30A may be recessed rearward from the front surface of the upper supporting portion 30. The user may easily move the modular movable robot 12 by putting his or her hand into the handle groove 30A.

A contact pad 80, which will be described later, may be mounted on the front side of the lower supporting portion 40. The contact pad 80 may be brought into close contact with the back of the body of the user.

The hip joint driving unit 50 may be fastened to the rear supporting portion 20. More specifically, the hip joint driving unit 50 may be fastened to the lower supporting portion 40.

The hip joint driving unit 50 may have a substantially U-shape.

The hip joint driving unit 50 may include a center portion 50A fastened to the lower portion of the rear supporting portion 20, that is, the lower supporting portion 40, and a pair of extension portions 50B and 50C extending from the center portion 50A to the hip joint side of the user.

The center portion 50A may cover part of the lower side on the opened back surface of the rear supporting portion 20.

The pair of extension portions 50B and 50C may include a first extension portion 50B extending from one side of the center portion 50A to the side of one leg of the user, and a second extension portion 50C extending from the other side of the center portion 50A to the side of the other leg of the user,

That is, the first extension portion 50B and the second extension portion 50C may extend from both ends of the rear supporting portion 20 to the hip joint side of the user.

The first extension portion 50B and the second extension portion 50C may be formed in a direction in which the height decreases toward the front side.

The hip joint driving unit 50 may further include a rotor 53 provided at the lower end of each of the first extension portion 50B and the second extension portion 50C.

The rotors 53 provided in the first extension portion 50B and the second extension portion 50C may rotate independently of each other.

A motor (not illustrated) for rotating the rotor 53 may be provided in each of the first extension portion 50B and the second extension portion 50C.

More specifically, each of the center portion 50A, the first extension portion 50B, and the second extension portion 50C may include an outer cover 51 and an inner cover 52. The outer cover 51 and the inner cover 52 may be fastened to each other. The outer cover 51 may be directed to the outside, and the inner cover 52 may be directed to the body of the user.

A motor accommodation space (not illustrated) in which the motor is accommodated may be formed between the outer cover 51 and the inner cover 52 included in the first extension portion 50B and the second extension portion 50C.

The first extension portion 50B and the second extension portion 50C may be provided with a side cover 57 for covering the motor accommodation space from the outside. In addition, the side cover 57 may be provided with a rotor adjusting portion 58 for controlling the rotation of the rotor 53.

The side cover 57 may be provided outside the lower portion of the first extension portion 50B or the second extension portion 50C. That is, the side cover 57 may be coupled to the outer cover 51 of the first extension portion 50B or the second extension portion 50C.

The user may control the rotation of the rotor 53 by operating the rotor adjusting portion 58.

The configuration of the rotor adjusting portion 58 is not limited. For example, when the user presses or touches the rotor adjusting portion 58, a signal is transmitted to the motor electrically connected to the rotor adjusting portion 58, and the motor may rotate the rotor 53.

In addition, the rotor 53 may be provided between the outer cover 51 and the inner cover 52. More specifically, a predetermined gap may be formed between the outer cover 51 and the inner cover 52 at a portion corresponding to the lower end of each of the first extension portion 50B and the second extension portion 50C, and the rotor 53 may be disposed in the gap.

The rotor 53 may rotate about the virtual rotational shaft X1. The virtual rotational shaft of the rotor 53 provided in the first extension portion 50B and the virtual rotational shaft of the rotor 53 provided in the second extension portion 50C may be disposed on a straight line. That is, the virtual rotational shaft X1 may be elongated in the horizontal direction, more specifically, in the lateral direction.

The wearable robot 1 may include a leg mounting portion 60 mounted on the legs of the user, more specifically, the thighs of the user, and a leg frame 70 rotated by the leg mounting portion 60 and the rotor 53 and connected to the leg mounting portion 60. The wearable robot 1 may further include a connector 54 for connecting the rotor 53 and the leg frame 70.

The leg mounting portion 60 may wrap around the thighs of the user. The leg mounting portion 60 may have a substantially circular ring shape.

A pair of leg mounting portions 60 may be provided. In this case, the pair of leg mounting portions 60 may include a first leg mounting portion 60A mounted on one of the thighs of the user and a second leg mounting portion 60B mounted on the other of the thighs of the user.

The leg frame 70 may be connected to the leg mounting portion 60 and may be rotated by the rotation of the rotor 53. Therefore, due to the rotation of the rotor 53, the leg mounting portion 60 may rotate and an assist force may be transmitted to the legs of the user.

A pair of leg frames 70 may be provided. In this case, the pair of leg frames 7 may include a first leg frame 70A rotated by the rotor 53 provided in the first extension portion 50B and connected to the first leg mounting portion 60A, and a second leg frame 70B rotated by the rotor 53 provided in the second extension portion 50C and connected to the second leg mounting portion 60B.

Each of the leg mounting portions 60 may include a leg binder 61, a leg belt 62, and a leg belt adjusting portion 63.

The leg binder 61 may include a hard material. For example, the leg binder 61 may include a metal material.

The leg binder 61 may be formed in a substantially circular arc shape so as to cover part of the thighs of the user.

The leg belt 62 may connect both ends of the leg binder 61 to each other. The leg belt 62 may include a soft material. The leg belt 62 may wrap the thighs of the user with the leg binder 61.

The leg binder 61 may be disposed in front of the leg belt 62. That is, both ends of the leg binder 61 may be directed substantially rearward.

The leg belt adjusting portion 63 may be provided in the leg binder 61.

The user may operate the leg belt adjusting portion 63 to tighten or loosen the leg belt 62.

The configuration of the leg belt adjusting portion 63 is not limited. For example, the user may tighten or loosen the leg belt 62 by gripping and rotating the leg belt adjusting portion 63. Therefore, the leg mounting portions 60 may be stably worn on the thighs of the user.

The leg frame 70 may be connected to the front side of the leg mounting portion 60. More specifically, the leg frame 70 may be connected to the upper end of the leg binder 61.

The upper end of the leg frame 70 may be connected to the rotor 53, and the lower end of the leg frame 70 may be connected to the fixing body 61. In this case, both sides of the upper end of the leg frame 70 may be directed left and right, respectively, and both sides of the lower end of the leg frame 70 may be directed back and forth, respectively.

The connector 54 may connect the rotor 53 and the leg frame 70.

The connector 54 may include a rotor connecting portion 55 connected to the rotor 53, and a leg frame mounting portion 56 which is hinged to the rotor connecting portion 55 and on which the upper end of the leg frame 70 is mounted.

The rotor connecting portion 55 may extend outward from the extension portions 50B and 50C through the gap formed between the outer cover 51 and the inner cover 52. Therefore, the rotor connecting portion 55 may not interfere with the extension portions 50B and 50C when the rotor 53 rotates.

The leg frame mounting portion 56 may be hinged to the rotor connecting portion 55. In this case, a hinge shaft may be formed to be long in the substantially front-rear direction. Therefore, the leg frame 70 and the leg mounting portion 60 may be rotatable about the hinge shaft. Therefore, the user may freely move the legs to the left and right.

Since the rotor 53 rotates about the virtual rotational shaft X1 in the horizontal direction and the leg frame 70 is connected to the front side of the leg mounting portion 60, the rotational force of the rotor 53 may be easily transmitted to the thighs of the user. For example, since the leg mounting portion 60 presses the tights of the user downward or backward when the rotor 53 is rotated downward, the wearable robot 1 may provide an assist force to spread the legs of the user.

In addition, since the hinge shaft of the connector 54 is formed to be long in the front-rear direction, it is possible to prevent the rotational force of the rotor 53 from being lost in the process of being transmitted to the leg frame 70.

Meanwhile, the wearable robot 1 may include a contact pad 80 and binders 110 and 120.

The contact pad 80 may be fastened in front of the rear supporting portion 20. More specifically, the contact pad 80 may be fastened in front of the lower supporting portion 40.

The contact pad 80 may be brought into close contact with the back of the body M of the user. The contact pad 80 may wrap the body M from the rear side.

The contact pad 80 may have a curved plate shape in which both end portions are bent toward the front side. The contact pad 80 is preferably ergonomically designed to correspond to the shape of the body M.

The contact pad 80 may be formed to be larger than the binders 110 and 120.

The binders 110 and 120 may press the contact pads 80. More specifically, the binders 110 and 120 may press the contact pad 80 toward the body M of the user.

Therefore, the contact pad 80 may be strongly in contact with the body M of the user, and the wearable robot 1 may be stably worn by the user. In addition, since the binders 110 and 120 press the contact pad 80 without directly touching the body M of the user, it is possible to prevent the user from feeling pain and to improve the fit of the user.

The binders 110 and 120 may be a rigid body. The binders 110 and 120 may have an arc shape having an inner circumference facing the body M of the user.

The binders 110 and 120 may be disposed outside the contact pad 80.

The binders 110 and 120 may be rotatably connected to the rear supporting portion 20. More specifically, the binders 110 and 120 may be rotatably connected to the lower supporting portion 40.

A plurality of binders 110 and 120 may be provided. For example, the plurality of binders 110 and 120 may include a pair of upper binders 110 and a pair of lower binders 120.

The upper binder 110 may be disposed above the lower binder 120.

The pair of upper binders 110 may include a first upper binder 110A rotatably connected to one side of the rear supporting portion 20, and a second upper binder 1108 rotatably connected to the other side of the rear supporting portion 20.

The first upper binder 110A and the second upper binder 1108 may be spaced apart from each other in the horizontal direction, more specifically, in the left-right direction. In this case, the first upper binder 110A may press one side of the upper portion of the contact pad 80, and the second upper binder 1108 may press the other side of the upper portion of the contact pad 80. That is, the contact pad 80 may be disposed between the first upper binder 110A and the second upper binder 1108.

The first upper binder 110A and the second upper binder 1108 may be connected to each other by an upper belt 111. The upper belt 111 may connect the first upper binder 110A and the second upper binder 1108 and may be adjustable in length.

The upper belt 111 may be wrapped around the front of the body M of the user.

One of the first upper binder 110A and the second upper binder 110B may be provided with an upper belt adjusting portion 112. The user may operate the upper belt adjusting portion 112 to tighten or loosen the upper belt 111.

The configuration of the upper belt adjusting portion 112 is not limited. For example, the user may tighten or loosen the upper belt 111 by gripping and rotating the upper belt adjusting portion 112.

When the user adjusts the upper belt adjusting portion 112 to tighten the upper belt 111, the distance between the first upper binder 110A and the second upper binder 1108 becomes close to each other, and the upper portion of the contact pad 80 may be pressed toward the body M of the user.

On the contrary, when the user adjusts the upper belt adjusting portion 112 to loosen the upper belt 111, the distance between the first upper binder 110A and the second upper binder 1108 increases and the contact pad 80 may not be pressed.

The lower binder 120 may be disposed below the upper binder 110. Part of the lower binder 120 adjacent to the rear supporting portion 20 may be disposed inside the hip joint driving unit 50.

The pair of lower binders 120 may include a first lower binder 120A rotatably connected to one side of the rear supporting portion 20, and a second lower binder 1208 rotatably connected to the other side of the rear supporting portion 20.

The first lower binder 120A and the second lower binder 120B may be spaced apart from each other in the horizontal direction, more specifically, in the left-right direction. In this case, the first lower binder 120A may press one side of the lower portion of the contact pad 80, and the second lower binder 1208 may press the other side of the lower portion of the contact pad 80. That is, the contact pad 80 may be disposed between the first lower binder 120A and the second lower binder 1208.

The first lower binder 120A and the second lower binder 120B may be connected to each other by a lower belt 121. The lower belt 121 may connect the first lower binder 120A and the second lower binder 1208 and may be adjustable in length.

The lower belt 121 may be wrapped around the front of the body M of the user.

One of the first lower binder 120A and the second lower binder 120B may be provided with a lower belt adjusting portion 122. The user may operate the lower belt adjusting portion 122 to tighten or loosen the lower belt 121.

The configuration of the lower belt adjusting portion 122 is not limited. For example, the user may tighten or loosen the lower belt 121 by gripping and rotating the lower belt adjusting portion 122.

When the user adjusts the lower belt adjusting portion 122 to tighten the lower belt 121, the distance between the first lower binder 120A and the second lower binder 1208 becomes close to each other, and the lower portion of the contact pad 80 may be pressed toward the body M of the user.

On the contrary, when the user adjusts the lower belt adjusting portion 122 to loosen the lower belt 121, the distance between the first lower binder 120A and the second lower binder 1208 increases and the contact pad 80 may not be pressed.

The upper belt 111 and the lower belt 121 may include a soft material.

The wearable robot 1 may be fixed to the chest and abdomen of the body M by the upper binder 110 and the lower binder 120, respectively. Therefore, it is possible to prevent the wearable robot 1 from sliding down when the wearer acts while wearing the wearable robot 1.

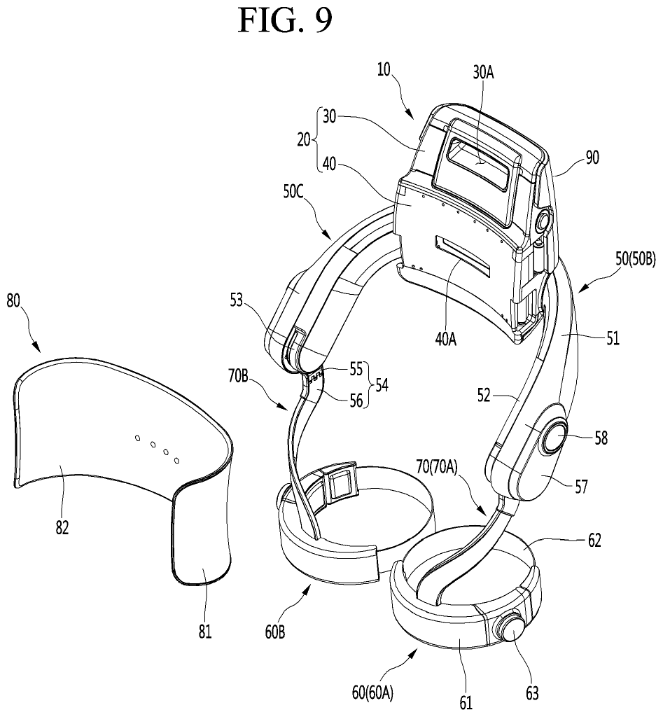

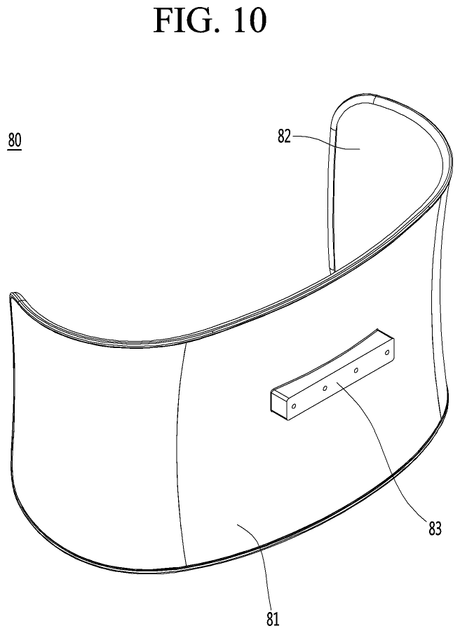

FIG. 9 is a view illustrating a state in which the contact pad is mounted on the rear supporting portion, according to an embodiment, and FIG. 10 is a rear view of the contact pad according to the embodiment.

The contact pad 80 may include a support plate 81 and a cushion 82 provided on the front surface of the support plate 81.

The support plate 81 may include a hard material. The support plate 81 may be a frame for determining the shape of the contact pad 80.

The inner surface of the support plate 81, that is, the surface facing the body M of the user, may have a streamlined shape that is convex forward as the distance from the upper edge and the lower edge of the support plate 81 increases. Therefore, the contact pad 80 may more closely contact the waist of the user.

The support plate 81 may be fastened to the rear supporting portion 20. More specifically, a protrusion portion 83 protruding toward the rear supporting portion 20 may be formed on the back surface of the support plate 81.

In this case, an insertion groove 40A into which the protrusion portion 83 is inserted may be formed on the front surface of the rear supporting portion 20. More specifically, the insertion groove 40A may be formed by being recessed rearward from the front surface of the lower supporting portion 40.

Therefore, the protrusion portion 83 may be inserted into the insertion groove 40A, and the installation position of the contact pad 80 may be guided. Thereafter, a fastening member (not illustrated) such as a screw may be fastened to the insertion groove 40A through the support plate 81 and the protrusion portion 83. Therefore, the contact pad 80 may be fastened to the rear supporting portion 20.

The cushion 82 may include a soft material. The cushion 82 may include an elastic material.

The cushion 82 may be provided on the front surface of the support plate 81. The cushion 82 may also surround the edge of the support plate 81.

The cushion 82 may be in close contact with the body M of the user. Since the cushion 82 includes a soft and elastic material, the contact area with the body M may be increased. Therefore, a friction force between the contact pad 80 and the body M increases, and the wearable robot 1 may be more stably worn on the body M.

Therefore, since the wearable robot 1 can be fixed to the body M only by the contact pad 80, the adjustment of the binders 110 and 120 and the leg binder 61 may be facilitated by the user alone, and the attachment and detachment of the wearable robot 1 may be facilitated.

In addition, as compared with the conventional method in which the wearable robot is fixed to the body M only by the binder 110 and the belts 121 and 122, a comfortable and stable feeling may be provided to the user by the contact pad 80 including the cushion 82.

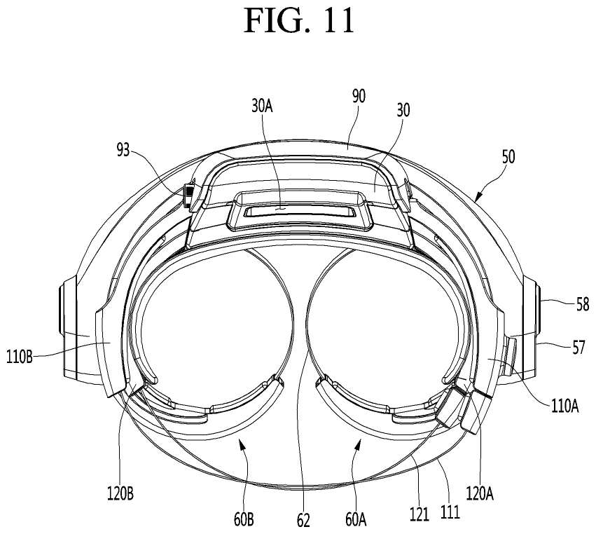

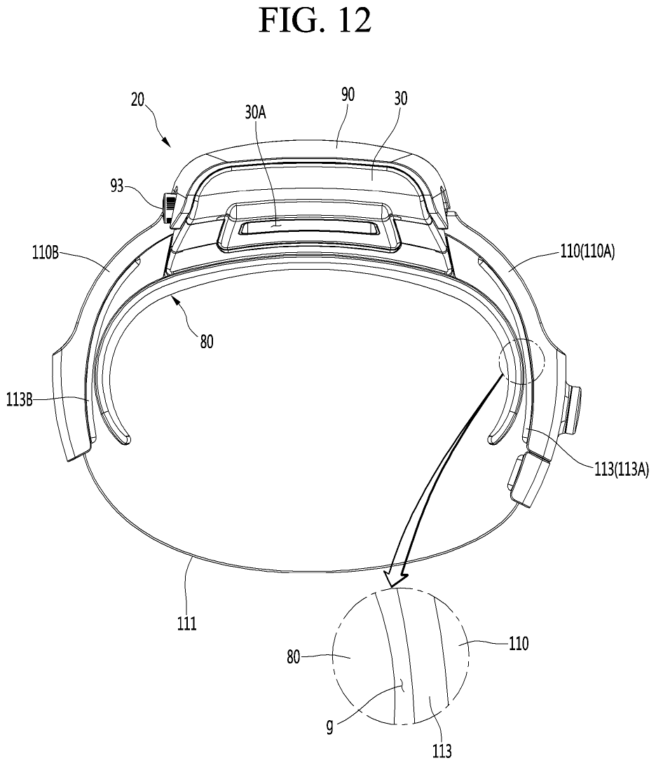

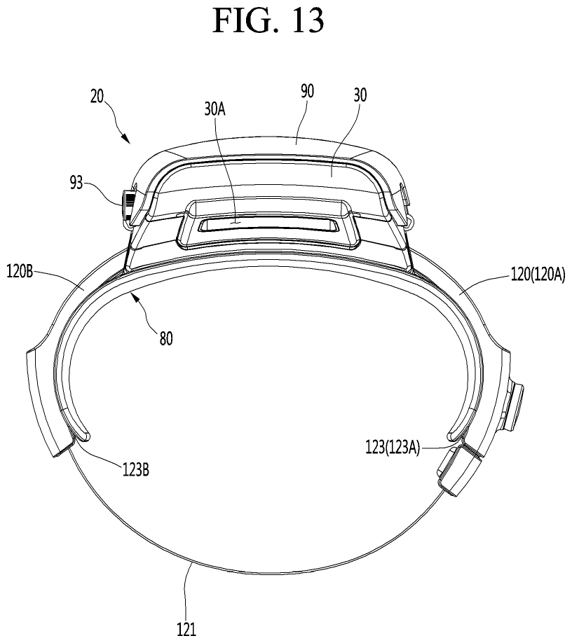

FIG. 11 is a plan view of the wearable robot according to the embodiment, FIG. 12 is a view illustrating the upper binder and the contact pad according to an embodiment, and FIG. 13 is a view illustrating the lower binder and the contact pad according to an embodiment.

At least part of the space inside the leg mounting portion 60 may vertically overlap the space inside the binders 110 and 120 and the belts 111 and 121. That is, the leg may be inserted into the leg mounting portion 60 from the upper side to the vertically lower side of the wearable robot 1. Therefore, the user may easily attach and detach the wearable robot 1 even when the user is standing.

The inner surfaces of the binders 110 and 120 may be directed to the body M of the user and the contact pad 80. Pressing portions 113 and 123 may be provided on the inner surfaces of the binders 110 and 120.

When the binders 110 and 120 press the contact pad 80, the pressing portions 113 and 123 may come into contact with the contact pad 80.

The pressing portions 113 and 123 may include an elastic material such as rubber or silicone. When the binders 110 and 120 press the contact pads 80, the pressing portions 113 and 123 may be pressed and elastically deformed between the binders 110 and 120 and the contact pad 80. Therefore, the pressing portions 113 and 123 may absorb an impact between the binders 110 and 120 and the contact pad 80.

More specifically, the upper pressing portion 113 may be provided on the inner surface of the upper binder 110. More specifically, the first upper pressing portion 113A may be provided on the inner surface of the first upper binder 110A, and the second upper pressing portion 1138 may be provided on the inner surface of the second upper binder 1108.

In addition, the lower pressing portion 123 may be provided on the inner surface of the lower binder 120. More specifically, the first lower pressing portion 123A may be provided on the inner surface of the first lower binder 120A, and the second lower pressing portion 1238 may be provided on the inner surface of the second lower binder 120B.

The pressing portions 113 and 123 may be separated from or come into contact with the contact pad 80 according to the rotation state of each of the binders 110 and 120. For example, when the user tightens only the lower belt 121, the lower pressing portion 123 may come into contact with the contact pad 80, and the upper pressing portion 113 may be separated from the contact pad 80. That is, a predetermined gap g may be formed between the contact pad 80 and the upper pressing portion 113.

Meanwhile, the inner surface of the upper binder 110 and the inner surface of the lower binder 120 may have different curvatures.

The inner surface of the upper binder 110 may have a first curvature, and the inner surface of the lower binder 120 may have a second curvature larger than the first curvature. That is, the inner surface of the lower binder 120 may have a curvature larger than that of the inner surface of the upper binder 110.

This is because the body M is generally thicker in the abdomen than in the chest. That is, since the inner surfaces of the upper binder 110 and the lower binder 120 have different curvatures, the contact pad 80 may be pressed according to body characteristics. Therefore, the feeling of wearing of the user may be further improved.

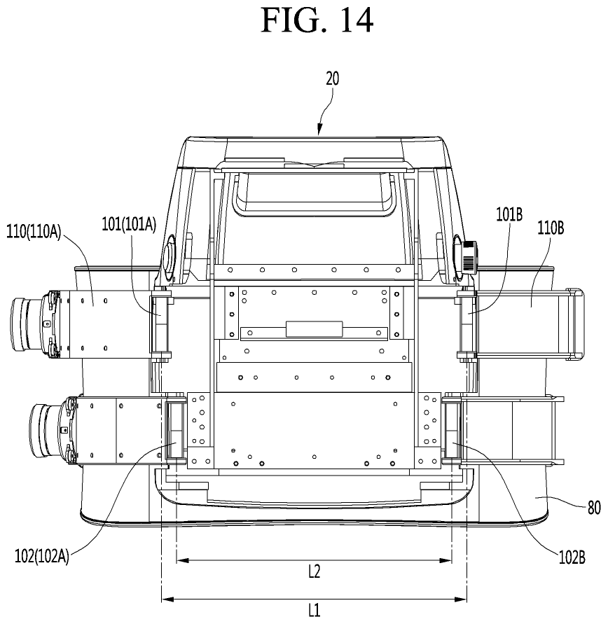

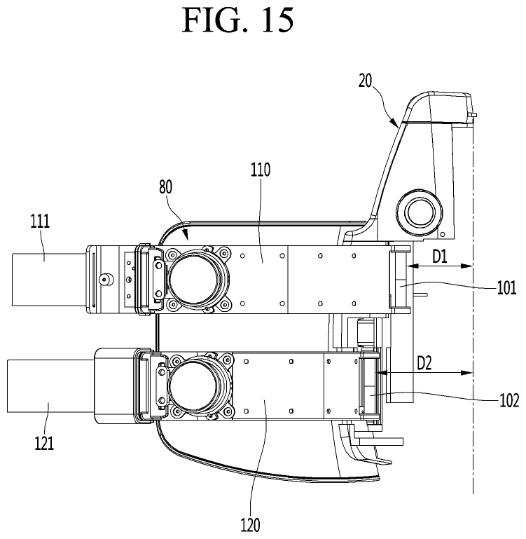

FIG. 14 is a rear view illustrating the upper rotational shaft and the lower rotational shaft according to an embodiment, and FIG. 15 is a side view illustrating the upper rotational shaft and the lower rotational shaft according to an embodiment.

As described above, the binders 110 and 120 may be rotatably connected to the rear supporting portion 20. More specifically, the rear supporting portion 20 may be provided with rotational shafts 101 and 102 to which the binders 110 and 120 are connected. More specifically, the lower supporting portion 40 may be provided with rotational shafts 101 and 102 to which the binders 110 and 120 are connected.

The rotational shafts 101 and 102 may be covered by at least one of the center portion 50A of the hip joint driving unit 50 (see FIG. 5) or the rear cover 90.

The rotational shafts 101 and 102 may be elongated in the vertical direction, and the binders 110 and 120 may be rotated in the front-rear direction.

The pair of upper binders 110 may be connected to the pair of upper rotational shafts 101. In this case, the pair of upper rotational shafts 101 may include a first upper rotational shaft 101A to which the first upper binder 110A is connected, and a second upper rotational shaft 101B to which the second upper binder 110B is connected.

The pair of lower binders 120 may be connected to the pair of lower rotational shafts 102. In this case, the pair of lower rotational shafts 102 may include a first lower rotational shaft 102A to which the first lower binder 120A is connected, and a second lower rotational shaft 102B to which the second lower binder 120B is connected.

The first upper rotational shaft 101A and the second lower rotational shaft 102A may be provided on one side of the rear supporting portion 20, and the second upper rotational shaft 101B and the second lower rotational shaft 102B may be provided on the other side of the rear supporting portion 20.

The first upper rotational shaft 101A and the second upper rotational shaft 101B may be spaced apart from each other in the horizontal direction. In addition, the first lower rotational shaft 102A and the second lower rotational shaft 102B may be spaced apart from each other in the horizontal direction.

In this case, the horizontal distance L2 between the pair of lower rotational shafts 102 may be shorter than the horizontal distance L1 between the pair of upper rotational shafts 101. That is, the pair of upper rotational shafts 101 may be spaced apart from each other by a first distance L1 in the horizontal direction, and the pair of lower rotational shafts 102 may be spaced apart from each other by a second distance L2 shorter than the first distance L1 in the horizontal direction.

A midpoint of the pair of upper rotational shafts 101 and a midpoint of the pair of lower rotational shafts 102 may be disposed on a virtual vertical plane M1 crossing the rear supporting portion 20. That is, when the wearable robot 1 is viewed from the rear side, the midpoint of the pair of upper rotational shafts 101 and the midpoint of the pair of lower rotational shafts 102 may be disposed on a straight line in the vertical direction.

In addition, the longitudinal distance D2 between the rear end of the rear supporting portion 20 and the lower rotational shaft 102 may be longer than the longitudinal distance D1 between the rear end of the rear supporting portion 20 and the upper rotational shaft 101.

This is because the body M is generally thicker in the abdomen than in the chest. That is, due to the above-described configuration of the upper rotational shaft 101 and the lower rotational shaft 102, the upper binder 110 and the lower binder 120 may press the contact pad 80 according to the body characteristics. Therefore, the feeling of wearing of the user may be further improved.

In accordance with a preferred embedment of the present disclosure, since the binders press the contact pad without directly touching the body of the user, it is possible to prevent the user from feeling pain and to improve the fit of the user.

In addition, since the cushion included in the contact pad includes a soft and elastic material, the contact area between the contact pad and the body may be increased. Therefore, a friction force between the contact pad and the body increases, and the wearable robot may be more stably worn on the body.

In addition, since the wearable robot may be provisionally fixed to the body by the friction force of the contact pad, the adjustment of the binders and the leg binder may be facilitated by the user alone, and the attachment and detachment of the wearable robot may be facilitated.

In addition, due to the friction force of the contact pad, the wearable robot may be prevented from sliding down when the user acts while wearing the wearable robot.

The above description is merely illustrative of the technical idea of the present disclosure, and various modifications and changes may be made thereto by those skilled in the art without departing from the essential characteristics of the present disclosure.

Therefore, the embodiments of the present disclosure are not intended to limit the technical spirit of the present disclosure but to illustrate the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

1. A wearable robot, comprising:
a rear supporting portion disposed behind a body of a user;
a hip joint driving unit including a center portion fastened to the rear supporting portion and a pair of extensions portions extending from the center portion to a hip joint of the user;
a contact pad fastened in front of the rear supporting portion and brought into close contact with a back of the body of the user; and
a binder rotatably connected to the rear supporting portion and configured to press the contact pad.

2. The wearable robot of claim 1, wherein the contact pad comprises:
a support plate fastened to the rear supporting portion and including a hard material; and
a cushion provided on a front surface of the support plate, having an elastic material and closely contacting the body of the user.

3-6. (canceled)

7. The wearable robot of claim 2, wherein a protrusion portion protruding toward the rear supporting portion is formed on a back surface of the support plate, and an insertion groove into which the protrusion portion is inserted is be formed on a front surface of the rear supporting portion.

8. The wearable robot of claim 1, wherein the binder comprises:
a first binder configured to press the contact pad in one side thereof; and
a second binder spaced apart from the first binder in a horizontal direction and configured to press the contact pad in the other side thereof,
wherein the contact pad is disposed between the first binder and the second binder.

9. The wearable robot of claim 8, further comprising a belt configured to connect the first binder and the second binder and be adjustable in length,
wherein the first binder and the second binder are spaced apart from the contact pad if the belt is a first length, and the first binder and the second binder contact and press the contact pad, if the belt is a second length shorter than the first length.

10. The wearable robot of claim 1, wherein the binder comprises: a pair of upper binders spaced apart from each other in a horizontal direction and pressing both top sides of the contact pad; and
a pair of lower binders spaced apart from each other in a horizontal direction and pressing both bottom sides of the contact pad,
wherein part of the top side of the contact pad is disposed between the pair of upper binders, and part of the bottom side of the contact pad is be disposed between the pair of lower binders.

11. The wearable robot of claim 10, wherein a curvature of an inner side of the lower binder is greater than a curvature of an inner side of the upper binder.

12. The wearable robot of claim 1, wherein a waist contact pad is larger than the binder.

13. The wearable robot of claim 1, wherein an inner surface of the binder includes a pressing portion in contact with the contact pad,
wherein the pressing portion includes an elastic material.

14. The wearable robot of claim 1, further comprising a rear cover for covering part of a top side among an opened bear surface of the rear supporting portion,
wherein the center portion is configured to cover part of a bottom side among the opened bear surface of the rear supporting portion.

15. The wearable robot of claim 14, further comprising a light emitting unit disposed between the rear cover and the center portion.

16. The wearable robot of claim 1, wherein the rear supporting portion comprises:
an upper supporting portion disposed at a back of the user; and
a lower supporting portion disposed in a bottom side of the upper supporting portion, disposed at a waist of the user and fastened in the center portion.

17. The wearable robot of claim 16, wherein the contact pad is fastened in the front of the lower supporting portion.

18. The wearable robot of claim 1, further comprising:
a leg mounting portion configured to cover a thigh of the user;
a rotor included in a bottom end of the extension portion and rotated on a long rotating shaft in a left and right direction; and
a leg frame revolved by the rotor and connected to the leg mounting portion.

19. The wearable robot of claim 18, wherein the leg mounting portion comprises:
a leg binder having a circular arc shape and including a hardened material; and
a leg belt connecting both ends of the leg binder and including a soft material.

20. The wearable robot of claim 18, wherein the leg frame is connected to a front end of the leg mounting portion.

21. The wearable robot of claim 18, wherein an upper end of the leg frame is connected to the rotor, both sides of the upper end of the leg frame face right and left, respectively, and
a lower end of the leg frame is connected to the leg mounting portion, and both sides of the lower end of the leg frame face back and forth, respectively.

22. The wearable robot of claim 18, further comprising: a connector connecting the rotor and the leg frame and having a hinge axis long back and forth.
